(19) United States
(12) Patent Application Publication
(10) Pub. No.: US 2020/0111360 A1
(43) Pub. Date: Apr. 9, 2020

(54) TRAIN DETECTOR FOR EMBEDDED RAIL

(71) Applicant: HARSCO TECHNOLOGIES LLC, Fairmont, MN (US)

(72) Inventors: Mike ZAMPINI, Fairmont, MN (US); John WIGGINS, Fairmont, MN (US); William STROHFELDT, Fairmont, MN (US); William HARTUNG, Fairmont, MN (US); Matthew NEGRI, Fairmont, MN (US); Dexter HART, Fairmont, MN (US); Zach TAYLOR, Fairmont, MN (US); Dallin WILLIAMS, Fairmont, MN (US)

(21) Appl. No.: 16/593,222

(22) Filed: Oct. 4, 2019

Related U.S. Application Data
(60) Provisional application No. 62/741,128, filed on Oct. 4, 2018.

(51) Int. Cl. G08G 1/123; G08B 7/06; G01S 17/02

(52) U.S. Cl. CPC G08G 1/123; G01S 17/026; G08B 7/06

(57) ABSTRACT

In a particular implementation, a vehicle detector configured to detect a train entering a work zone includes a detector portion including one or more motion detectors. The one or more motion detectors are configured to detect a vehicle entering a work zone. The vehicle detector also includes a vertical member coupled to the detector portion. The vehicle detector further includes a stabilizing structure including one or more components configured to stabilize the vertical member. The one or more components define a circumference around the vertical member.

### CROSS-REFERENCE TO RELATED APPLICATIONS

This application claims the benefit of priority of U.S. Provisional Patent Application No. 62/741,128 filed Oct. 4, 2018, the entire contents of which are hereby incorporated by reference in their entirety.

### FIELD OF DISCLOSURE

The present disclosure relates generally to train detectors for detecting trains on embedded rail, such as rail embedded in pavement of automobile traffic lanes.

### BACKGROUND

Work zones that include embedded rail, such as rail embedded in pavement of automobile traffic lanes, may pose dangers to workers. For example, a number of workers and vehicles may be present in the work zone, and injuries to the workers and damage to the vehicles may occur if a train enters the work zone without the workers' knowledge. Thus, works zones that include active track (e.g., track with trains or other vehicles moving thereon) pose safety challenges to workers in the work zone.

### SUMMARY

The present disclosure relates to apparatus, systems, and methods for improving safety in a work zone with embedded rail. Such safety improvements may be provided by a vehicle detector that is configured to detect when a vehicle, such as a train, enters the work zone. In some implementations described herein, the vehicle detector has a narrow profile to enable the vehicle detector to fit into tight spaces adjacent to embedded track. The vehicle detector includes a detector portion that includes one or more motion sensors configured to detect when a vehicle (e.g., a train) enters the work zone. In some implementations, the vehicle detector also includes a vertical member coupled to the detector portion and a stabilizing structure including one or more components configured to stabilize the vertical member. The one or more components define a circumference around the vertical member. In some implementations, the one or more components include a sheet of material the defines a cone around the vertical member. For example, the vertical member may be coupled to a ground plate, and the cone may be disposed over at least a portion of the vertical member such that the cone is in contact with the ground plate and stabilizes the vertical member. In other implementations, the one or more components may include three additional members, such that a tripod is formed to support the vertical member. These implementations (e.g., the cone and/or the tripod) have a narrow profile and enable the vehicle detector to fit into tight spaces adjacent to the embedded track. In still other implementations, instead of including the vertical member and the stabilizing structure, the detector portion may be mounted to a fore or aft portion of a second vehicle (e.g., a truck, a car, etc.). For example, the detector portion may be magnetically coupled to a trailer hitch of the second vehicle. Thus, the vehicle detector may be mounted on a vehicle that is already in the work zone, instead of disposed as a separate object.

The vehicle detector is configured to alert one or more workers when a vehicle (e.g., a train) enters the work zone. In some implementations, the vehicle detector includes one or more alert indicators configured to indicate an alert based on detection of the vehicle entering the work zone. The alert may be a visual alert, an audio alert, or both. For example, the vehicle detector may include one or more light emitting diodes (LEDs) configured to emit light based on detection of the vehicle entering the work zone. As another example, the vehicle detector may include a speaker configured to output an audio sound, such as a siren sound or other sound, based on detection of the vehicle entering the work zone. Additionally, in some implementations, the vehicle detector includes a communications interface that is communicatively coupled to one or more personal alarm devices (PADs) carried or worn by one or more workers. The communications interface may be configured to transmit an alert signal to the one or more PADs based on detection of the vehicle entering the work zone. The PADs may be configured to provide an indication, such as a visual indication, an audio indication, a haptic indication, or a combination thereof, based on receiving the alert signal. For example, the PADs may include one or more LEDs configured to emit light based on the alert signal, a speaker configured to emit an audio sound based on the alert signal, or a component configured to cause vibration of the PAD based on the alert signal. In this manner, workers in the work zone may be alerted when a vehicle is entering the work zone, which may reduce or prevent injury to the workers.

Some aspects of a present vehicle detector configured to detect a train entering a work zone comprise a detector portion comprising one or more motion detectors. The one or more motion detectors are configured to detect a vehicle entering a work zone. The vehicle detector also comprises a vertical member coupled to the detector portion. The vehicle detector further comprises a stabilizing structure comprising one or more components configured to stabilize the vertical member. The one or more components define a circumference around the vertical member.

In some of the foregoing aspects, the one or more components comprise a sheet of material that defines a cone around the vertical member. Alternatively, the one or more components comprise at least three members coupled to the vertical member and configured to stabilize the vertical member. Additionally or alternatively, the one or more motion detectors comprises one or more laser beam emitters. The vehicle is detected as entering the work zone based on reflection of laser beams emitted from the one or more laser beam emitters. Additionally, or alternatively, the one or more motion detectors include a first motion detector configured to detect motion of the vehicle in a first direction, a second motion detector configured to detect motion of the vehicle in the first direction, a third motion detector configured to detect motion of the vehicle in a second direction, or a combination thereof.

In some of the foregoing aspects, the vehicle detector further comprises a ground plate coupled to the vertical member, wherein the one or more components define the circumference on the ground plate. Additionally, or alternatively, the vertical member is coupled to the detector portion by a tube. The tube is configured to adjust a height of the detector portion. Additionally, or alternatively, the vehicle detector further comprises a mounting bracket coupled to the detector portion and to the vertical member. The mounting bracket is configured to enable the detector portion to be rotated in a first direction, in a second direction, or both. The first direction is perpendicular to the second direction. In some such aspects, the mounting bracket is configured to enable the detector portion to be rotated in the first direction in 15 degree increments, in the second direction in 90 degree increments, or both.

In some of the foregoing aspects, the vehicle detector further comprises one or more level indicators. The one or more level indicators are configured to indicate an orientation of the detector portion with respect to a first axis, a second axis, or both. The first axis is perpendicular to the second axis. Additionally, or alternatively, the detector portion further comprises one or more alarm indicators configured to indicate an alarm based on detection of the vehicle entering the work zone. The alarm is a visual alarm, an audio alarm, or both.

Some aspects of a present vehicle detector configured to detect a train entering a work zone comprise a detector portion comprising one or more motion detectors. The one or more motion detectors are configured to detect a vehicle entering a work zone. The vehicle detector further comprises means for mounting the detector portion to a fore or aft portion of a second vehicle.

In some of the foregoing aspects, the means for mounting comprises a mounting bracket. In some such aspects, the mounting bracket is configured to enable the detector portion to be rotated in a first direction, in a second direction, or both. The first direction is perpendicular to the second direction. Alternatively, the means for mounting comprises one or more magnets.

Some aspects of a present system comprise a vehicle detector comprising a detector portion comprising one or more motion sensors. The one or more motion sensors are configured to detect a vehicle entering a work zone. The vehicle detector also comprises a vertical member coupled to the detector portion. The vehicle detector further comprises a stabilizing structure comprising one or more components to stabilize the vertical member. The one or more components define a circumference around the vertical member.

In some of the foregoing aspects, the detector portion further comprises a communications interface configured to transmit an alert signal based on detection of the vehicle entering the work zone. In some such aspects, the system further comprises one or more personal alert devices communicatively coupled to the detector portion. The one or more personal alert devices are configured to generate an indication based on receipt of the alert signal from the communication interface. In some such aspects, the indication comprises a visual indication, an audio indication, a haptic indication, or a combination thereof. Additionally, or alternatively, the system further comprises a portable warning device communicatively coupled to the detector portion. The portable warning device is configured to generate an indication based on receipt of the alert signal from the communication interface. In some such aspects, the indication comprises a visual indication, an audio indication, or both.

Some aspects of a present method comprise providing a detector portion of a vehicle detector. The detector portion comprises one or more motion sensors configured to detect a vehicle entering a work zone. The method comprises providing a vertical member. The method comprises coupling the detector to the portion to the vertical member. The method also comprises providing a stabilizing structure comprising one or more components. The method further comprises stabilizing the vertical member by coupling the stabilizing structure to the vertical member. The one or more components define a circumference around the vertical member.

In some of the foregoing aspects, the method further comprises coupling the vertical member to a ground plate. The one or more components comprise a sheet of material that defines a cone around the vertical member. Alternatively, the one or more components comprise at least three members coupled to the vertical member and configured to stabilize the vertical member. Additionally, or alternatively, the method may further comprise adjusting a first orientation of the detector portion with respect to a first axis, adjusting a second orientation of the detector portion with respect to a second axis, or both. The first axis is perpendicular to the second axis.

Some aspects of a present method comprise providing a detector portion of a vehicle detector. The detector portion comprises one or more motion sensors configured to detect a vehicle entering a work zone. The method also includes providing a fore or aft portion of a second vehicle. The method further includes mounting the detector portion on the fore or aft portion of the second vehicle.

In some of the foregoing aspects, the method further includes mounting the detector portion to the fore or aft portion of the second vehicle via a mounting bracket. Alternatively, the method may further include magnetically mounting the detector portion to the fore or aft portion of the vehicle. Additionally, or alternatively, the method may further include adjusting a first orientation of the detector portion with respect to a first axis, adjusting a second orientation of the detector portion with respect to a second axis, or both. The first axis is perpendicular to the second axis.

Some aspects of a present method comprise detecting, at a detector portion of a vehicle detector that includes a vertical member coupled to the detector portion and a stabilizing structure comprising one or more components configured to stabilize the vertical member, a vehicle entering a work zone. The vehicle is detected by one or more motion sensors of the detector portion. The method further includes transmitting, from the detector portion to a personal alert device, an alert signal.

In some of the foregoing aspects, the alert signal enables the personal alert device to generate an indication. In some such aspects, the indication is a visual indication, an audio indication, a haptic indication, or a combination thereof. Additionally, or alternatively, the method may further comprise generating an indication at the detector portion based on detection of the vehicle entering the work zone. In some such aspects, generating the indication comprises emitting light from one or more light emitting diodes (LEDs), emitting an audio output from a speaker, or both.

Some aspects of a present method comprise detecting, at a detector portion of a vehicle detector mounted to a fore or aft portion of a second vehicle, a vehicle entering a work zone. The vehicle entering the work zone is detected via one or more motion sensors of the detector portion. The method further comprises transmitting, from the detector portion to a personal alert device, an alert signal.

In some of the foregoing aspects, the alert signal enables the personal alert device to generate an indication. In some such aspects, the indication is a visual indication, an audio indication, a haptic indication, or a combination thereof. Additionally, or alternatively, the method may further comprise generating an indication at the detector portion based on detection of the vehicle entering the work zone. In some such aspects, generating the indication comprises emitting light from one or more light emitting diodes (LEDs), emitting an audio output from a speaker, or both.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed embodiment, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or. To illustrate, A, B, and/or C includes: A alone, B alone, C alone, a combination of A and B, a combination of A and C, a combination of B and C, or a combination of A, B, and C. In other words, “and/or” operates as an inclusive or. Additionally, the phrase “A, B, C, or a combination thereof” or “A, B, C, or any combination thereof” includes: A alone, B alone, C alone, a combination of A and B, a combination of A and C, a combination of B and C, or a combination of A, B, and C.

The terms “comprise” and any form thereof such as “comprises” and “comprising,” “have” and any form thereof such as “has” and “having,” and “include” and any form thereof such as “includes” and “including” are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any implementation of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, it will be understood that the term “wherein” may be used interchangeably with “where.”

Further, a device or system that is configured in a certain way is configured in at least that way, but it can also be configured in other ways than those specifically described. Aspects of one example may be applied to other examples, even though not described or illustrated, unless expressly prohibited by this disclosure or the nature of a particular example. Some details associated with the aspects described above and others are described below.

Some details associated with the aspects are described above, and others are described below. Other implementations, advantages, and features of the present disclosure will become apparent after review of the entire application, including the following sections: Brief Description of the Drawings, Detailed Description, and the Claims.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 depicts an example of a first implementation of a vehicle detector.

FIG. 2 depicts a second view of the vehicle detector of FIG. 1.

FIG. 3 depicts a third view of the vehicle detector of FIG. 1.

FIG. 4 depicts a portion of the vehicle detector of FIG. 1.

FIG. 5 depicts an example of a second implementation of a vehicle detector.

FIG. 6 depicts an example of a third implementation of a vehicle detector.

FIG. 7 depicts a system that provides warnings to workers when a vehicle enters a work zone.

FIG. 8 depicts the system of FIG. 7 in a second work zone.

FIG. 9 is a block diagram of a system for warning workers when a vehicle enters a work zone.

FIG. 10 is a flow diagram of a first example of a method assembling a vehicle detector.

FIG. 11 is a flow diagram of a second example of a method of assembling a vehicle detector.

FIG. 12 is a flow diagram of a first example of a method of transmitting an alert signal when a vehicle is detected entering a work zone.

FIG. 13 is a flow diagram of a second example of a method of transmitting an alert signal when a vehicle is detected entering a work zone.

FIG. 14 is a block diagram of an example of a kit for a vehicle detector.

### DETAILED DESCRIPTION

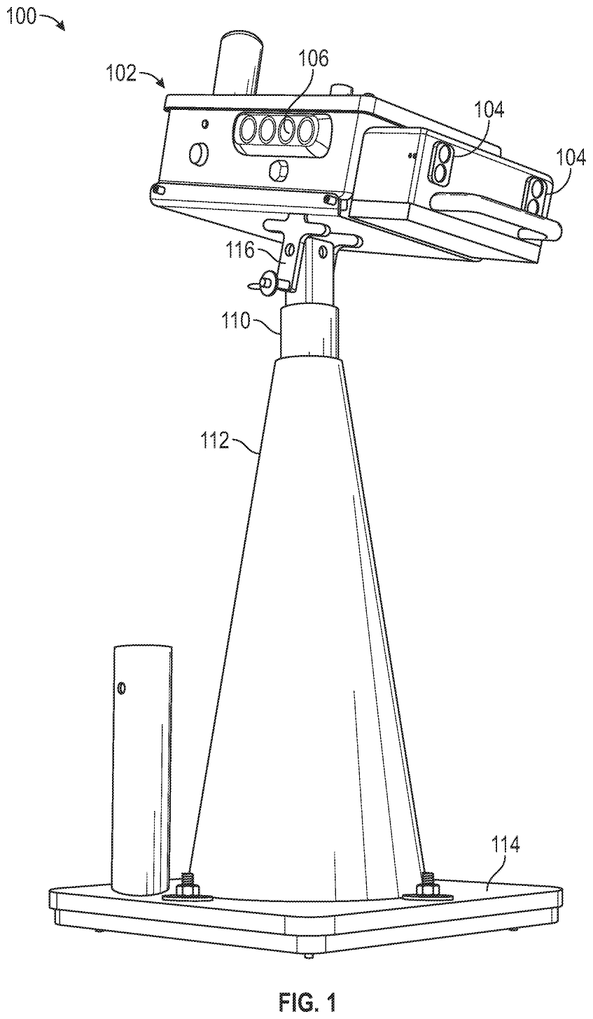

Referring to FIG. 1, a vehicle detector 100 is shown. Vehicle detector 100 may be configured to detect when a vehicle, such as a train, enters a work zone. Vehicle detector 100 may provide indication(s) when the detection is made, as well as transmitting alert signals to other devices, such as personal alarm devices, as further described herein. Thus, vehicle detector 100 may improve safety of workers in a work zone with embedded rail on which trains run.

Vehicle detector 100 includes a detector portion 102. Detector portion 102 is configured to detect when a vehicle, such as a train, enters a work zone. Detector portion 102 may include one or more motion sensors 104 and a visual indicator 106.

One or more motion sensors 104 may include one or more motion sensors 104 that are configured to detect when the vehicle enters the work zone. For example, one or more motion sensors 104 may be configured to detect motion in plane across a set of rails, thereby indicating that a vehicle, such as a train, has entered the work zone. In some implementations, one or more motion sensors 104 include one or more laser beam emitters configured to emit laser beams and one or more receivers configured to receive reflections of the laser beams. For example, the laser beam emitters may emit the laser beams, and when a vehicle enters the work zone, the laser beams may strike the vehicle and be reflected such that the receivers receive the reflected laser beams and detect the vehicle. In other implementations, other types of motion sensors may be used, such as infrared emitters, radio wave emitters, or other types of motion sensors. In some implementations, one or more motion sensors 104 may have a range of 10 meters. In other implementations, one or more motion sensors 104 may have a range that is less than or greater than 10 meters.

In some implementations, one or more motion sensors 104 may include a first motion sensor configured to detect motion in a first direction, a second motion sensor configured to detect motion in the first direction, and a third motion sensor configured to detect motion in a second direction. For example, the first motion sensor and the second motions sensor may include a pair of motion sensors directed in a first direction (e.g., across a set of rails), which may be used to detect when a train is entering the work zone (as opposed to leaving the work zone). For example, detection of reflection of laser beams at a first receiver (e.g., the left receiver) followed closely in time by detection of reflection of laser beams at a second receiver (e.g., the right receiver) may indicate that the train is entering the work zone (e.g., moving from left to right), as opposed to detection of reflection of lasers beams at the second receiver (e.g., the right receiver) followed closely in time by detection of reflection of laser beams at the second receiver (e.g., the left receiver), which may indicate that a train is leaving the work zone. The third motion sensor may be directed in a second direction (e.g., along the set of rails to the left) to detect a distance to an oncoming vehicle. Distance measurements can be used to determine a velocity of the approaching vehicle, and if the velocity satisfies a threshold, an alert can be indicated, as further described herein. In some implementations, one or more motion sensors 104 may include a fourth motion detector configured to detect motion in a third direction (e.g., along the set of rails to the right). In such implementations, vehicle detector 100 may be deployed along either side of a set of rails (e.g., train tracks), and at least one motion sensor will be directed in the direction of oncoming trains. Alternatively, the third and fourth motion sensor may be replaced by a rotatable motion sensor that may be rotated in a particular direction to detect distance to vehicles in the particular direction. In some other implementations, one or more motion sensors 104 include a single motion sensor.

Visual indicator 106 may be any type of visual indicator that provides a visual indication based on detection, by one or more motion sensors 104, of a vehicle entering the work zone. For example, visual indicator 106 may include one or more light emitting diodes (LEDs) configured to emit light based on detection of a vehicle entering the work zone. In some implementations, the LEDs may be different colors, or may be set to flash at an interval (or different intervals). In other implementations, visual indicator 106 may be a different type of light or other visual indicator. The visual indication provided by visual indicator 106 may alert workers in the work zone to the oncoming vehicle. In some implementations, detector portion 102 may also include a speaker. The speaker may be configured to emit an audio output, such as a siren, a horn, or another sound, based on detection, by one or more motion sensors 104, of a vehicle entering the work zone. The audio output may alert workers in the work zone to the oncoming vehicle. In some implementations, detector portion 102 further includes a communications interface configured to send an alert signal to one or more personal alert devices (PADs) worn by one or more workers, and/or to other devices, based on detection of a vehicle entering the work zone, as further described herein.

Vehicle detector 100 also includes a vertical member 110 and a stabilizing structure 112. Vertical member 110 is coupled to detector portion 102 and is affixed to the ground to support vertical member 110 at a particular height. Vertical member 110 may be any type of member, such as a rod, a beam, or any other type of member. In some implementations, vehicle detector 100 may include a ground plate 114, and vertical member 110 may be coupled to ground plate 114. In some implementations, ground plate 114 may include a recess configured to receive at least a portion of vertical member 110 and keep vertical member 110 from wobbling, especially in windy conditions. Ground plate 114 may be substantially square, rectangular, or any other shape that supports vertical member 110 and detector portion 102. In some implementations, the length and/or the width of ground plate 114 may be 10 or 11 inches, as non-limiting examples. In some implementations, ground plate 114 may be weighted to provide support and stabilization to vertical member 110. For example, the ground plate may weigh approximately 5 pounds (lbs.), 7 lbs., 8 lbs., or 16 lbs., as non-limiting examples.

In some implementations, vehicle detector 100 is configured to be used next to embedded rail (e.g., rail that is embedded in a street or road). In some such implementations, ground plate 114 is substantially flat and weighted such that ground plate 114 easily rests on asphalt or concrete of the street or of a sidewalk next to the street. In other implementations, vehicle detector 100 may be used in other environments, such as a field, rocky terrain, or anywhere else where rails are found. In some such implementations, ground plate 114 may include one or more feet in order to be more stable in non-flat terrain. Additionally, or alternatively, ground plate 114 may include one or more attachment mechanisms, such as spikes, to be driven into the ground to stabilize ground plate 114. Thus, ground plate 114 may be configured for use in multiple different types of terrain, increasing the locations that vehicle detector 100 may be deployed.

Stabilizing structure 112 may be coupled to vertical member 110 and configured to stabilize vertical member 110. For example, stabilizing structure 112 may include one or more components configured to stabilize vertical member 110. The one or more components define a circumference around vertical member 110. For example, the circumference may be defined around a bottom (or bottom portion) of vertical member 110. In implementations in which ground plate 114 is included, the circumference may be defined on ground plate 114.

Stabilizing structure 112 (e.g., the one or more components) may include any type and number of components that are capable of providing stabilization to vertical member 110. In some implementations, the one or more components of stabilizing structure 112 may include a sheet of material that defines a cone around vertical member 110. For example, the cone may be disposed over a portion of vertical member 110 and may be positioned on the ground (or on ground plate 114). In some implementations, the cone may have a first opening at a first end (e.g., a first opening at a top end) and a second opening at a second end (e.g., a second opening at a bottom end), and vertical member 110 may extend through one or both of the openings. The cone may have various dimensions. For example, the cone may have a height of 12 inches, 18 inches, or 28 inches, as non-limiting examples. The cone may have a diameter of 10 or 11 inches, as non-limiting examples. In some implementations, the cone is removable. In other implementations, the cone is fixed to vertical member 110. In some implementations that include ground plate 114, ground plate 114 may include one or more clips, hinges, or other attachments configured to attach the cone to ground plate 114 and enable the cone to provide support to vertical member 110. The sheet of material (e.g., the cone) may be made of rubber, plastic, metal, or another material. Additionally, the sheet of material (e.g., the cone) may be any color. In some implementations, the cone is black, as illustrated in FIG. 1. In other implementations, the cone is a bright color to draw workers' attention to vehicle detector 100. As illustrated in FIG. 1, the cone (e.g., stabilizing structure 112) defines a circumference around vertical member 110 on ground plate 114. For example, the second opening may define the circumference around the vertical member 110 on ground plate 114.

In some other implementations, stabilizing structure 112 may include at least three members coupled to vertical member 110 and configured to stabilize vertical member 110. For example, stabilizing structure 112 may include a tripod configured to stabilize vertical member 110. The bottom portions of the tripod legs may define a circumference around the bottom portion of vertical member 110. The tripod may be removable or may be fixed to vertical member 110. In some implementations, stabilizing structure 112 may include more than three members for additional support. In still other implementations, stabilizing structure 112 may be a different type of supporting structure.

In some implementations, detector portion 102 is coupled to vertical member 110 by a mounting bracket 116. Mounting bracket 116 may be configured to enable detector portion 102 to be rotated in a first direction, a second direction, or both. The first direction is perpendicular to the second direction. For example, mounting bracket 116 may include movable joints that enable detector portion 102 to be rotated in the first direction (e.g., forwards and backwards) and/or the second direction (e.g., left and right). In some implementations, mounting bracket 116 is configured to enable detector portion to be moved in the first direction in 15 degree increments, in the second direction in 90 degree increments, or both. In other implementations, mounting bracket 116 is configured to enable motion in the various directions by other increments.

In some implementations, vehicle detector 100 includes one or more level indicators. The one or more level indicators may be configured to indicate an orientation of detector portion 102 with respect to a first axis, a second axis, or both. The first axis is perpendicular to the second axis. For example, vehicle detector 100 may include a first level indicator indicating a first orientation of detector portion 102 with respect to an x-axis (e.g., a horizontal axis) and a second level indicator indicating a second orientation of detector portion 102 with respect to a y-axis (e.g., a vertical axis). The level indicators may be liquids within small glass tubes with reference lines to indicate the orientation of the detector portion 102, or any other type of level indicators.

During operation, vehicle detector 100 is set up adjacent to embedded rail (or in other implementations non-embedded rail) at the entrance to a work zone. Detector portion 102 (e.g., one or more motion sensors 104) detects when a vehicle, such as a train, enters the work zone. For example, one or more motion sensors 104 may emit laser beams in a direction across the embedded rails, and when a vehicle passes the laser beams, detection of reflected laser beams indicates that the vehicle has entered the work zone. Additionally, or alternatively, one or more motion sensors 104 may emit laser beams in a direction along the embedded rails to detect distances to oncoming vehicles (and velocities of the oncoming vehicles, in some implementations). Based on detection of the vehicle, visual indicator 106 may generate a visual indication of an alert (e.g., one or more LEDs may emit light), and, if included, a speaker may generate an audio indication of an alert (e.g., a siren sound, a horn sound, etc.). Additionally, in some implementations, detector portion 102 may transmit a warning signal to one or more other devices, such as one or more PADs, as further described herein.

Thus, FIG. 1 describes vehicle detector 100 that is configured to indicate, to one or more workers, when a vehicle, such as a train, enters a work zone. For example, vehicle detector 100 is configured to output a visual indication (and/or an audio indication) to workers in a work zone that a vehicle has entered the work zone. Because vehicle detector 100 is relatively small (e.g., has a footprint similar to that of a traffic cone, in some implementations), vehicle detector 100 may be placed in tight spaces adjacent to embedded rail, such as rail embedded in a street, to provide warnings to workers of when a vehicle enters the work zone. Providing warnings to works can increase the safety of the workers and reduce or prevent injuries to the workers.

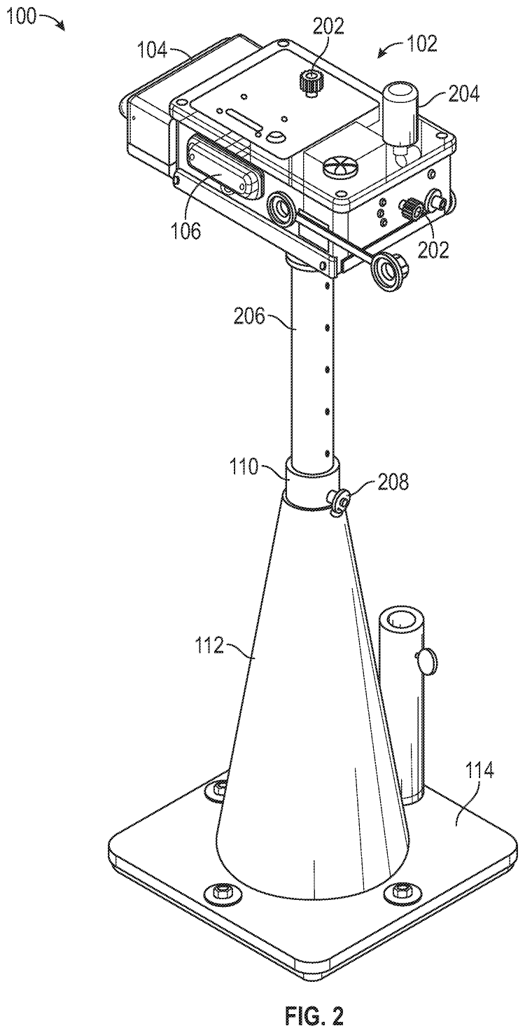

Referring to FIG. 2, a second view of vehicle detector 100 is illustrated. The second view illustrates additional components of vehicle detector 100. For example, detector portion 102 may further include one or more knobs 202 and an antenna 204. One or more knobs 202 may be configured to enable a user to select between various options at detector portion 102. As one non-limiting example, a first knob may be used to select whether detector portion 102 outputs a visual indication, an audio indication, both, or no indication when a vehicle is detected entering the work zone. As another example, a second knob may be used to select a visual indication mode (such as between emitting light, flashing light, selection of color of light, etc.) or an audio indication mode (e.g., selection between one or more different sounds output by detector portion 102).

Antenna 204 is configured to receive and transmit wireless signals from detector portion 102. For example, a communication interface (internal to detector portion 102) and antenna 204 may be configured to transmit an alert signal when a vehicle is detected as entering the work zone. The alert signal may be transmitted to one or more other devices, as further described herein.

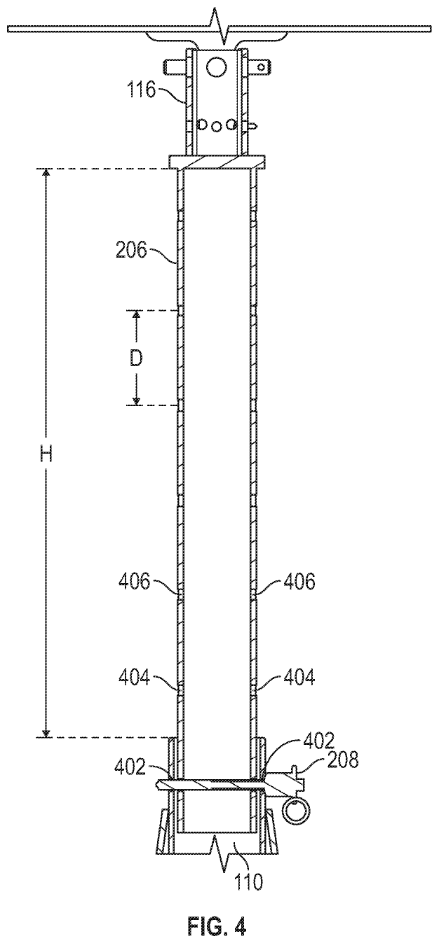

In some implementations, vehicle detector 100 also includes a tube 206. Tube 206 may be configured to adjust a height of detector portion 102. For example, tube 206 may have a plurality of holes, and insert 208 may be configured to be inserted into a particular hole to set the height of detector portion 102 (e.g., from the ground), as further described with reference to FIG. 4. Insert 208 may include a rod, a screw, or another form of insert. Insert 208 may be metal, plastic, or another material.

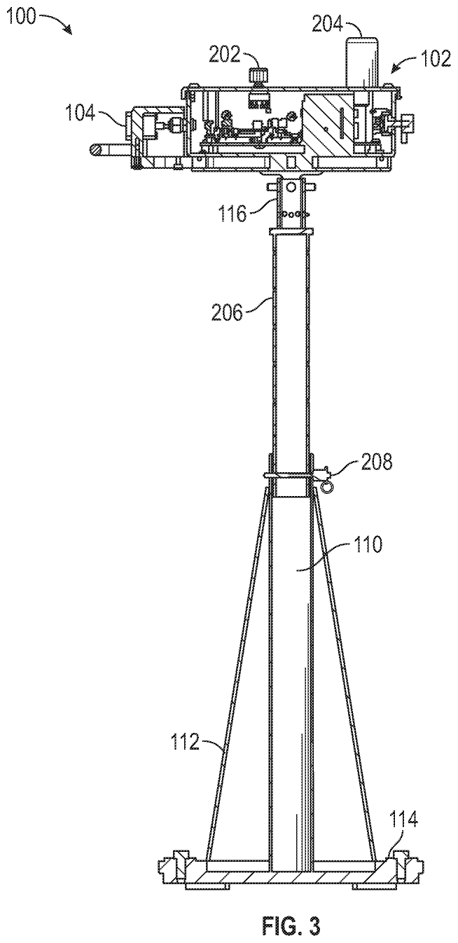

Referring to FIG. 3, a third view of vehicle detector 100 is shown. In FIG. 3, detector portion 102 and stabilizing structure 112 (e.g., the cone) are illustrated as transparent such that interior components are visible. For example, detector portion 102 may include one or more circuit boards that include a processor, a memory, and a communications interface. Additionally, as shown in FIG. 3, stabilizing structure 112 (e.g., the cone) may be displaced over at least a portion of vertical member 110. In some implementations, vertical member 110 and stabilizing structure 112 may be coupled to (or fixed to) ground plate 114, as shown in FIG. 3.

Referring to FIG. 4, a view of a portion of vehicle detector 100 is shown. In FIG. 4, a close-up view of tube 206 is illustrated. Tube 206 may be sized such that tube 206 fits within vertical member 110. Additionally, tube 206 may include a plurality of sets of holes, such as the illustrative sets of holes illustrated in FIG. 4. For example, tube 206 may include a first set of holes 402, a second set of holes 404, and a third set of holes 406. Although seven sets of holes are illustrated in FIG. 4, in other implementations, less than seven or more than seven sets of holes may be included in tube 206.

Insert 208 may be inserted into a set of holes to set the height of detector portion 102 relative to the ground. To illustrate, in FIG. 4, insert 208 is inserted into first set of holes 402 (e.g., the lowest set of holes). When configured in this manner, the majority of tube 206 extends above vertical member 110, raising detector portion 102 to as high a height as possible. If insert 208 is inserted in second set of holes 404 or third set of holes 406, a portion of tube 206 slides down within vertical member 110, and detector portion 102 is lowered. Thus, use of insert 208 and tube 206 enable a height of detector portion 102 to be set. In some implementations, a height H of tube 206 is 12 inches, and a distance D between each set of holes is 2 inches. In other implementations, H and D have different values.

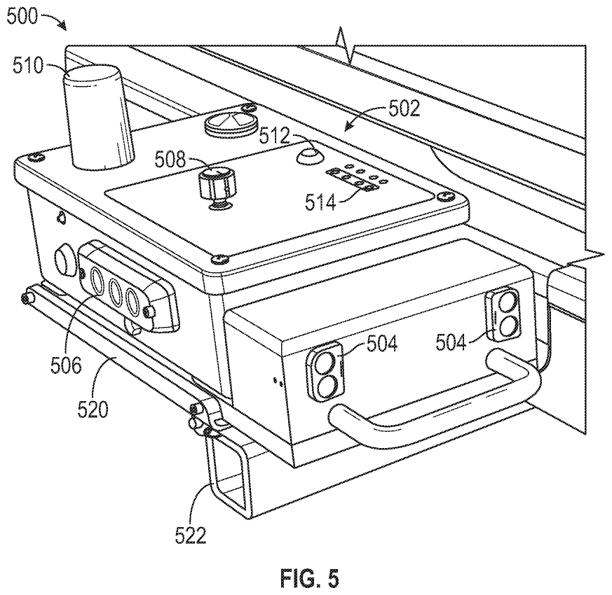

Referring to FIG. 5, a second implementation of a vehicle detector 500 is shown. Vehicle detector 500 may be configured to detect when a vehicle, such as a train, enters a work zone. Vehicle detector 500 may provide indication(s) when the detection is made, as well as transmitting alert signals to other devices, such as personal alarm devices, as further described herein. Thus, vehicle detector 500 may improve safety of workers in a work zone with embedded rail on which trains run.

Vehicle detector 500 includes a detector portion 502. Detector portion 502 is configured to detect when a vehicle, such as a train, enters a work zone. Detector portion 502 may include a one or more motion sensors 504 and a visual indicator 506. Additionally, in some implementations, detector portion 502 may include one or more knobs 508, an antenna 510, a power button 512, and a battery indicator 514.

One or more motion sensors 504 may include or correspond to one or more motion sensors 104. For example, in some implementations, one or more motion sensors 504 may include one or more laser beam emitters and receivers configured to determine when a vehicle enters a work zone by emitting laser beams and receiving reflections of the laser beams. In other implementations, one or more motion sensors 504 may be other types of motion sensors. Visual indicator 506 may include or correspond to visual indicator 106. For example, in some implementations, visual indicator 506 may include one or more LEDs configured to emit light when one or more motion sensors 504 detect a vehicle entering the work zone. In some implementations, detector portion 502 further includes a speaker configured to emit an audio output, such as a siren, when one or more motion sensors 504 detect a vehicle entering the work zone.

One or more knobs 508 may be configured to select one or more options with respect to detector portion 502. As a non-limiting example, one or more knobs 508 may be configured to select a type of indication that is output by detector portion 502 when a vehicle is detected as entering the work zone, such as a visual output, an audio output, both, or no output. Antenna 510 may be configured to wirelessly transmit and/or receive signals to or from other devices. For example, a communications interface (included in detector portion 502) and antenna 510 may be configured to transmit an alert signal to one or more devices, such as one or more PADs, as further described herein. Power button 512 may be configured to power on (or power off) detector portion 502. Battery indicator 514 may be configured to indicate a power level of a battery of detector portion 502. For example, the number of lights of battery indicator 514 that are lit up may indicate the strength of the battery. Alternatively, only one light may be lit up at a time to indicate the strength of the battery. In some implementations, each light may have a different color. Although four lights are illustrated in FIG. 5, in other implementations, battery indicator 514 may include less than four or more than four lights.

Vehicle detector 500 also includes a means for mounting detector portion 502 to a fore or aft portion of a second vehicle. The second vehicle may be a truck, a car, a sport utility vehicle, a work vehicle, or any other type of vehicle used in the work zone or by a worker. In some implementations, the means for mounting include mounting bracket 520. For example, mounting bracket 520 may mount detector portion 502 to a trailer hitch 522. In some implementations, mounting bracket 520 may be configured to enable detector portion 502 to be rotated in a first direction, in a second direction, or both. The first direction is perpendicular to the second direction. For example, mounting bracket 520 may be configured to enable detector portion 502 to rotate front to back, left to right, or both, as described with reference to FIG. 1. In some other implementations, the means for mounting includes one or more magnets. For example, detector portion 502 may be mounted to trailer hitch 522 via one or more magnets coupled to the bottom of detector portion 502.

During operation, vehicle detector 500 may be set up adjacent to embedded rail at the entrance to a work zone. For example, a second vehicle (e.g., a truck) to which vehicle detector 500 is coupled may be parked near the entrance to the work zone. Detector portion 502 (e.g., one or more motion sensors 504) detects when a vehicle, such as a train, enters the work zone. For example, one or more motion sensors 504 may emit laser beams in a direction across the embedded rails, and when a vehicle passes the laser beams, detection of reflected laser beams indicates that the vehicle has entered the work zone. Based on detection of the vehicle, visual indicator 506 may generate a visual indication of an alert (e.g., one or more LEDs may emit light), and, if included, a speaker may generate an audio indication of an alert (e.g., a siren sound, a horn sound, etc.). Additionally, in some implementations, detector portion 502 may transmit a warning signal to one or more other devices, such as one or more PADs, as further described herein.

Thus, FIG. 5 describes vehicle detector 500 that is configured to indicate, to one or more workers, when a vehicle, such as a train, enters a work zone. For example, vehicle detector 500 is configured to output a visual indication (and/or an audio indication) to workers in a work zone that a vehicle has entered the work zone. Because vehicle detector 500 is coupled to a second vehicle (e.g., a truck, a car, etc.), vehicle detector 500 may not take up any additional space at the work zone while providing warnings to workers of when a vehicle enters the work zone. Providing warnings to works can increase the safety of the workers and reduce or prevent injuries to the workers.

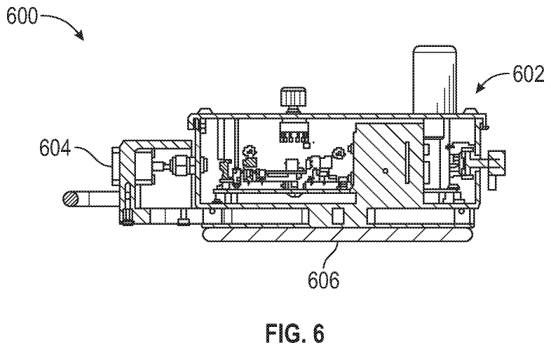

Referring to FIG. 6, a third implementation of a vehicle detector 600 is shown. Vehicle detector 600 may be similar to vehicle detector 500, and thus most components are not described for convenience. For example, vehicle detector 600 includes a detector portion 602 that includes one or more motion sensors 604, similar to vehicle detector 500 of FIG. 5.

Unlike vehicle detector 500 of FIG. 5, vehicle detector 600 further includes one or more magnets 606. One or more magnets 606 may be coupled or attached to the bottom of detector portion 602. One or more magnets 606 are configured to be coupled to a fore or aft portion of a second vehicle (e.g., a truck, a car, etc.) to couple detector portion 602 to the second vehicle. In some implementations, one or more magnets 606 may be coupled to a trailer hitch of the second vehicle. In some other implementations, one or more magnets 606 may be coupled to a metallic bumper of the second vehicle. Thus, FIG. 6 illustrates another example of a vehicle detector that is configured to be coupled to a second vehicle, such as a truck, a car, etc.

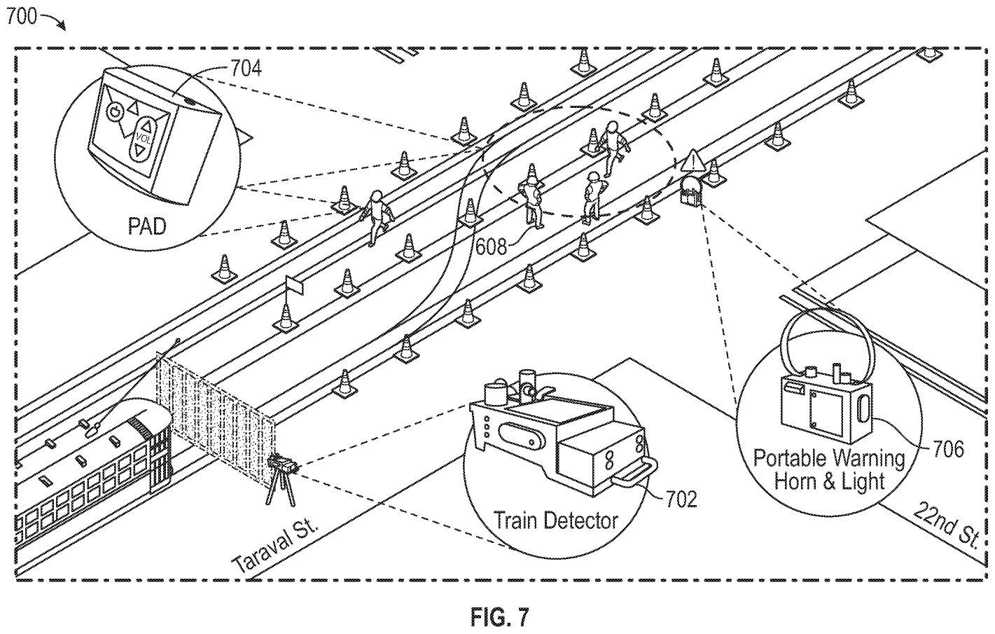

Referring to FIG. 7, a system 700 that provides warnings to workers when a vehicle enters a work zone is shown. System 700 includes a vehicle detector 702, one or more personal alarm devices (PADs) 704, and optionally a portable warning horn and light 706 (e.g., a portable warning device).

Vehicle detector 702 (also referred to as a train detector) may include or correspond to vehicle detector 100 or vehicle detector 500. For example, vehicle detector 702 may include a detector portion that includes one or more motion sensors configured to detect when a vehicle, such as a train, enters the work zone. The detector portion may also include a communications interface that is communicatively coupled to the one or more PADs 704 and to the portable warning horn and light 706. Although vehicle detector 702 is illustrated in FIG. 7 as emitting beams in a first direction across a set of embedded rails, in other implementations, vehicle detector 702 may include additional motion detectors that emit beams in directions along the set of embedded rails to detect the motion of oncoming vehicles (e.g., trains), enabling determination of a distance to an oncoming train, a velocity of the oncoming train, or both.

One or more PADs 704 may be carried by or worn by one or more workers, such as illustrative worker 708. One or more PADs 704 may be configured to provide an indication when a vehicle is detected as entering the work zone. The indication may be a visual indication, an audio indication, a haptic indication, or a combination thereof. For example, one or more PADs 704 may include lights (e.g., LEDs) or other visual indicators that are configured to visually indicate an alert (e.g., that a vehicle has entered the work zone). As another example, one or more PADs 704 may include a speaker configured to emit an audio output, such as a siren, to indicate the alert. As another example, one or more PADs 704 may be configured to vibrate to indicate the alert. The indication of the alert may be provided by one or more PADs 704 based on alert signals received from vehicle detector 702.

Portable warning horn and light 706 may also be configured to provide an indication when a vehicle is entering the work zone. The indication may be a visual indication, and audio indication, or both. For example, portable warning horn and light 706 may include one or more lights, such as LEDs, that are configured to emit light to indicate the alert (e.g., that a vehicle has entered the work zone). As another example, portable warning horn and light 706 may include a speaker, a horn, or some other form of audio output device that is configured to emit an audio output, such as a siren or a horn sound, to indicate the alert. The indication of the alert may be provided by the portable warning horn and light 706 based on an alert signal received from vehicle detector 702.

Vehicle detector 702, one or more PADs 704, and portable warning horn and light 706 may be communicatively coupled together. For example, vehicle detector 702, one or more PADs 704, and portable warning horn and light 706 may be capable of peer-to-peer communications and/or may be connected via a network. In some implementations, vehicle detector 702 may be configured to transmit radio frequency (RF) signals to one or more PADs 704 and to portable warning horn and light 706. As one example, the RF signals may be sent over a 900 megahertz (MHz) band. As another example, the RF signals may be sent over a 2400 MHz band. In some other implementations, vehicle detector 702 may transmit the alert signal to a dispatch system, and the dispatch system may transmit the alert signal to one or more PADs 704 and/or portable warning horn and light 706.

During operation of the system 700, vehicle detector 702 may be deployed near the entrance to the work zone to detect for oncoming vehicles entering the work zone. One or more workers may possess, such as wear, one or more PADs 704, and portable warning horn and light 706 may be deployed in a position near where a number of workers are working. When a vehicle entering the work zone is detected, vehicle detector 702 may output an alert, such as a visual alert, an audio alert, or both. Additionally, vehicle detector 702 may transmit an alert signal to one or more PADs 704 and portable warning horn and light 706. Based on the alert signal, one or more PADs 704 may indicate the alert by a visual indication, an audio indication, a haptic indication, or a combination thereof. Additionally, portable warning horn and light 706 may indicate the alert by a visual indication, an audio indication, or both. Thus, workers within the work zone may be alerted that a vehicle has entered the work zone, and the workers may move out of the way of a train track (or other vehicle path) to avoid injury. In some implementations, vehicle detector 702 may have a relatively small size, such that vehicle detector 702 can be deployed in tight spaces near the rail.

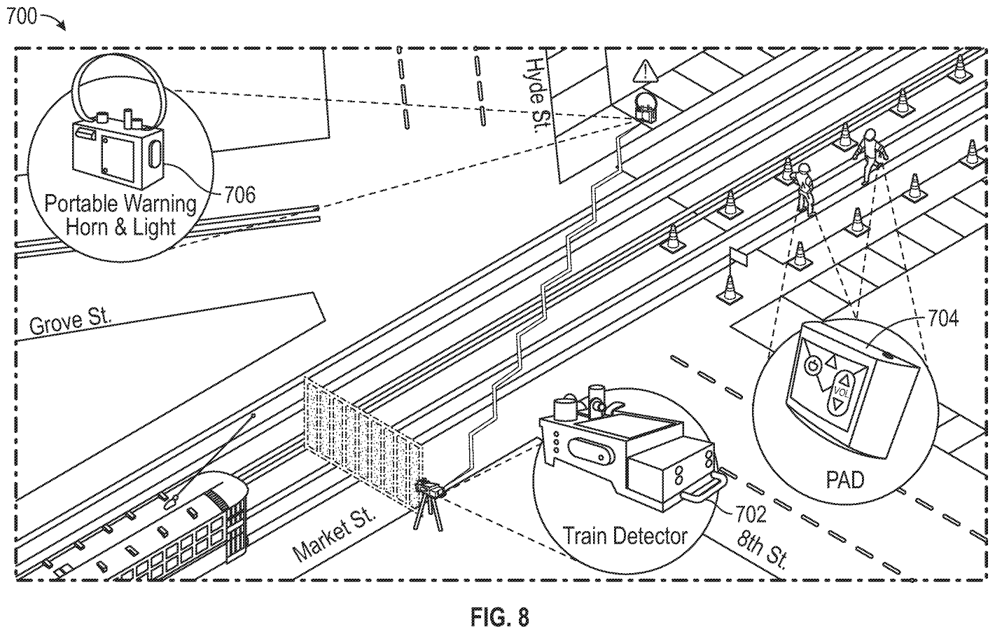

Referring to FIG. 8, system 700 is illustrated at a different work zone. System 700 includes the components described with reference to FIG. 7. For example, system 700 includes vehicle detector 702, one or more PADs 704, and portable warning horn and light 706. As shown in FIG. 8, when a vehicle is detected entering the work zone, vehicle detector 702 transmits an alert signal (indicated by the jagged line) to portable warning horn and light 706 to cause portable warning horn and light 706 to output an indication of the alert. Additionally, vehicle detector 702 may transmit the alert signal to one or more PADs 704 to cause one or more PADs 704 to output an indication of the alert. Thus, workers within the work zone may be alerted that a vehicle has entered the work zone, and the workers may move out of the way of a train track (or other vehicle path) to avoid injury.

Although a single vehicle detector 702 has been illustrated in FIGS. 7 and 8, in other implementations, more than one vehicle detector 702 may be deployed around a work zone. The multiple vehicle detectors 702 may be used to provide varying levels of alarms. For example, a first vehicle detector may be deployed in a position before the entrance to the work zone, such as 100 meters away, 200 meters away, 300 meters away, etc. The first vehicle detector may be configured to provide a first audio alarm, such as a beep or a horn sound, to indicate that a vehicle is approaching the work zone. A second vehicle detector may be deployed at the entrance to the work zone. The second vehicle detector may be configured to provide a second audio alarm, such as a siren sound, to indicate that the vehicle has entered the work zone. In this manner, workers in the work zone may have more time to prepare (e.g., to move themselves, their equipment, their vehicles, etc.) before the vehicle (e.g., the train) enters the work zone, which may improve worker safety and reduce or prevent injuries to the workers. Although two vehicle detectors 702 have been described in this example, any number of vehicle detectors 702 may be used. For example, vehicle detectors 702 may be deployed at different distances from (or along) the work zone, at different locations (e.g., if the train tracks curves and worker visibility is limited, a vehicle detector may be deployed around the curve), or in any setup that may increase worker safety.

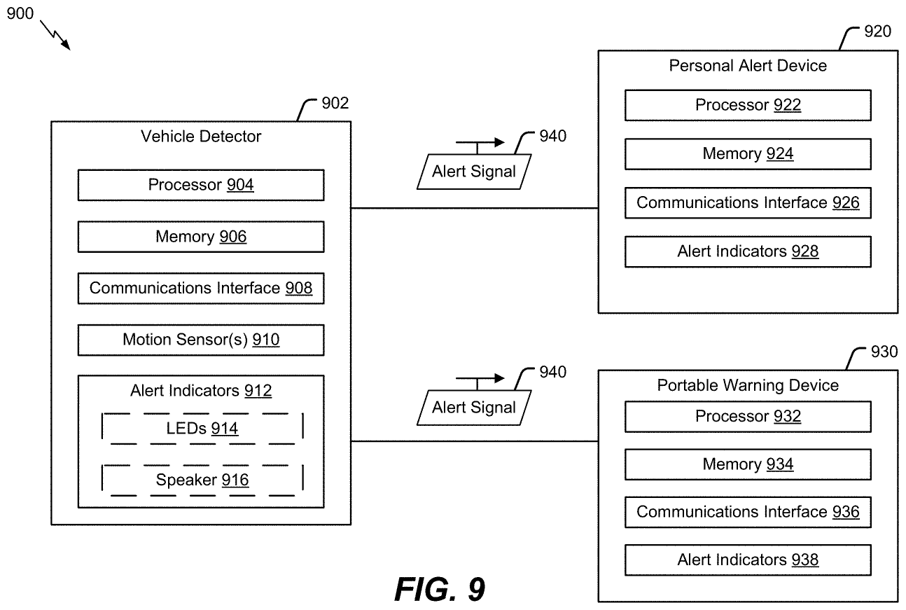

Referring to FIG. 9, a system for warning workers when a vehicle enters a work zone is shown. System 900 includes vehicle detector 902, personal alert device (PAD) 920, and portable warning device 930. Vehicle detector 902 may include or correspond to vehicle detector 100 of FIGS. 1-4, vehicle detector 500 of FIG. 5, or vehicle detector 702 of FIGS. 7-8. PAD 920 may include or correspond to one or more PADs 704 of FIGS. 7-8. Portable warning device 930 may include or correspond to portable warning horn and light 706 of FIGS. 7-8.

Vehicle detector 902 includes a processor 904, a memory 906, a communications interface 908, motion sensors 910, and alert indicators 912. Processor 904 may be configured to execute instructions stored at memory 906 to perform the operations described herein. Processor 904 may include a central processing unit (CPU), a graphics processing unit (GPU), or another type of processor. Memory 906 may include a read-only memory (ROM), a random-access memory (RAM), long-term storage (e.g., a disk drive, a storage device, etc.), or any other type of memory.

Communications interface 908 is configured to transmit data to one or more other devices, receive data from one or more other devices, or both. For example, communications interface 908 may transmit and/or receive data via peer-to-peer communications or via a network, such as a wired network, a wireless network, or a combination thereof. For example, communications interface 908 may be configured to transmit or receive data via a direct device-to-device connection, a local area network (LAN), a wide area network (WAN), a modem-to-modem connection, the Internet, intranet, extranet, cable transmission system, cellular communication network, any combination of the above, or any other communication network no known or later developed within which permits two or more electronic devices to communicate. In some implementations, communications interface 908 includes or corresponds to a transmitter, a receiver, or a transceiver. Communications interface 908 may be configured to transmit an alert signal 940 based on detection of a vehicle entering the work zone, as further described herein.

Motion sensors 910 are configured to detect motion within a field of vision of motion sensors 910. For example, motion sensors 910 may include one or more motion sensors configured to detect when a vehicle enters a work zone. In some implementations, motion sensors 910 may include one or more laser beam emitters and receivers configured to emit laser beams and to receive reflections of the laser beams, thereby indicating detection of the vehicle.

Alert indicators 912 are configured to provide an indication of an alert when motion sensors 910 detect a vehicle entering the work zone. The indication may be a visual indication, an audio indication, or both. For example, alert indicators 912 may include one or more LEDs 914 configured to emit light when the vehicle is detected. As another example, alert indicators 912 may include speaker 916 configured to emit an audio output, such as a siren or a horn, when the vehicle is detected. In some implementations, alert indicators 912 include both LEDs 914 and speaker 916. In other implementations, only one of LEDs 914 or speaker 916 is included in alert indicators 912.

PAD 920 includes a processor 922, a memory 924, a communications interface 926, and alert indicators 928. Processor 922 may be configured to execute instructions stored at memory 924 to perform the operations described herein. Processor 922 may include a CPU, a GPU, or another type of processor. Memory 924 may include a ROM, a RAM, long-term storage (e.g., a disk drive, a storage device, etc.), or any other type of memory.

Communications interface 926 is configured to transmit data to one or more other devices, receive data from one or more other devices, or both. For example, communications interface 926 may transmit and/or receive data via peer-to-peer communications or via a network, such as a wired network, a wireless network, or a combination thereof. For example, communications interface 926 may be configured to transmit or receive data via a direct device-to-device connection, a LAN, a WAN, a modem-to-modem connection, the Internet, intranet, extranet, cable transmission system, cellular communication network, any combination of the above, or any other communication network no known or later developed within which permits two or more electronic devices to communicate. In some implementations, communications interface 926 includes or corresponds to a transmitter, a receiver, or a transceiver.

Alert indicators 928 are configured to provide an indication of an alert when vehicle detector 902 detects a vehicle entering the work zone (e.g., based on receipt of alert signal 940). The indication may be a visual indication, an audio indication, a haptic indication, or a combination thereof. For example, alert indicators 928 may include one or more LEDs configured to emit light when alert signal 940 is received. As another example, alert indicators 928 may include a speaker configured to emit an audio output, such as a siren or a horn, when alert signal 940 is received. As another example, alert indicators 928 may include a haptic component configured to cause PAD 920 to vibrate when alert signal 940 is received.

Portable warning device 930 includes a processor 932, a memory 934, a communications interface 936, and alert indicators 938. Processor 932 may be configured to execute instructions stored at memory 934 to perform the operations described herein. Processor 932 may include a CPU, a GPU, or another type of processor. Memory 934 may include a ROM, a RAM, long-term storage (e.g., a disk drive, a storage device, etc.), or any other type of memory.

Communications interface 936 is configured to transmit data to one or more other devices, receive data from one or more other devices, or both. For example, communications interface 936 may transmit and/or receive data via peer-to-peer communications or via a network, such as a wired network, a wireless network, or a combination thereof. For example, communications interface 936 may be configured to transmit or receive data via a direct device-to-device connection, a LAN, a WAN, a modem-to-modem connection, the Internet, intranet, extranet, cable transmission system, cellular communication network, any combination of the above, or any other communication network no known or later developed within which permits two or more electronic devices to communicate. In some implementations, communications interface 936 includes or corresponds to a transmitter, a receiver, or a transceiver.

Alert indicators 938 are configured to provide an indication of an alert when vehicle detector 902 detects a vehicle entering the work zone (e.g., based on receipt of alert signal 940). The indication may be a visual indication, an audio indication, or both. For example, alert indicators 928 may include one or more LEDs configured to emit light when alert signal 940 is received. As another example, alert indicators 928 may include a speaker configured to emit an audio output, such as a siren or a horn, when alert signal 940 is received.

During operation of system 900, vehicle detector 902 is positioned near the entrance to the work zone and adjacent to a rail. When vehicle detector 902 (e.g., motion sensors 910) detect that a vehicle, such as a train, is entering the work zone, alert indicators 912 of vehicle detector 902 may indicate an alert. Additionally, communications interface 908 may transmit alert signal 940 to PAD 920 and to portable warning device 930. Based on receipt of alert signal 940, alert indicators 928 of PAD 920 may indicate an alert. Additionally, based on receipt of alert signal 940, alert indicators 938 of portable warning device 930 may indicate an alert. In this manner, workers in the work zone may be alerted when a vehicle, such as a train, enters the work zone. This alert may enable the workers to exit the work zone safely, thereby reducing or preventing injuries to the workers.

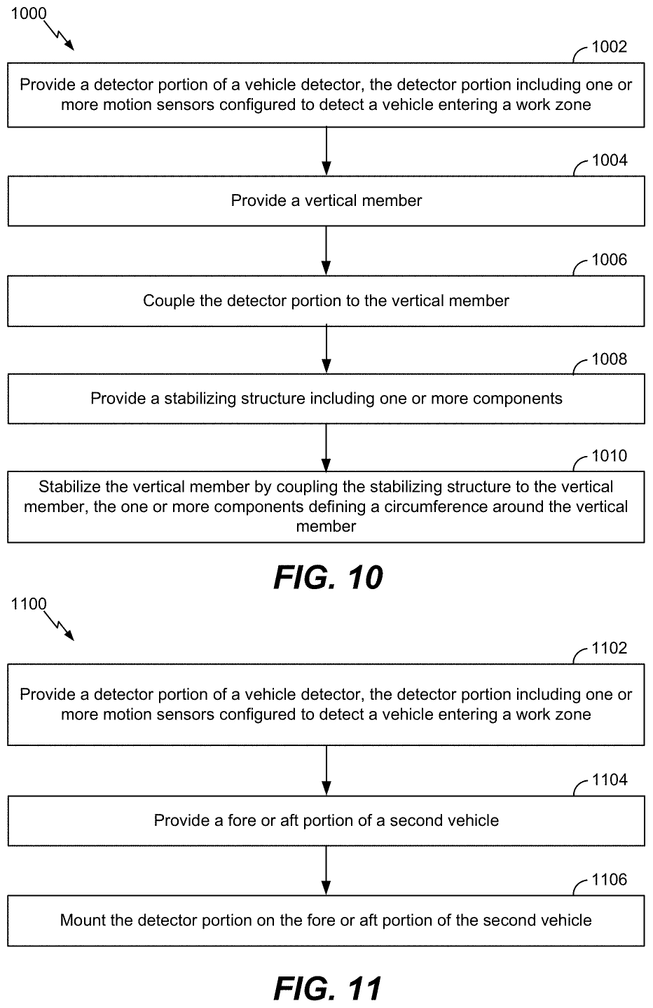

FIG. 10 illustrates an implementation of a method 1000 for assembling a vehicle detector. Method 1000 may be performed by a worker in a work zone.

Method 1000 includes providing a detector portion of a vehicle detector, at 1002. The detector portion includes one or more motion sensors configured to detect a vehicle entering a work zone. For example, detector portion 102 of vehicle detector 100, which includes one or more motion sensors 104, may be provided.

Method 1000 includes providing a vertical member, at 1004. For example, vertical member 110 may be provided. Method 1000 includes coupling the detector portion to the vertical member, at 1006. For example, detector portion 102 may be coupled to vertical member 110.

Method 1000 also includes providing a stabilizing structure including one or more components, at 1008. For example, stabilizing structure 112 may be provided.

Method 1000 further includes stabilizing the vertical member by coupling the stabilizing structure to the vertical member, at 1010. The one or more components define a circumference around the vertical member. For example, stabilizing structure 112 may be coupled to vertical member 110 to stabilize vertical member 110. Stabilizing structure 112 may include one or more components that define a circumference around vertical member 110, as described with reference to FIG. 1.

In some implementations, method 1000 further includes coupling the vertical member to a ground plate. The one or more components may include a sheet of material that defines a cone around the vertical member. For example, vertical member 110 may be coupled to ground plate 114. In some implementations, as described with reference to FIG. 1, stabilizing structure 112 may be a cone. Alternatively, the one or more components may include at least three members coupled to the vertical member and configured to stabilize the vertical member. For example, stabilizing structure 112 may include a tripod coupled to vertical member 110, as described with reference to FIG. 1.

In some implementations, method 1000 further includes adjusting a first orientation of the detector portion with respect to a first axis, adjusting a second orientation of the detector portion with respect to a second axis, or both. The first axis is perpendicular to the second axis. For example, mounting bracket 116 may enable detector portion 102 to be oriented in a first direction and/or a second direction. In some implementations, mounting bracket 116 enables detector portion 102 to be oriented in particular directions by particular increments.

FIG. 11 illustrates another implementation of a method 1100 for assembling a vehicle detector. Method 1100 may be performed by a worker in a work zone.

Method 1100 includes providing a detector portion of a vehicle detector, at 1102. The detector portion includes one or more motion sensors configured to detect a vehicle entering a work zone. For example, detector portion 502 of vehicle detector 500, which includes one or more motion sensors 504, may be provided.

Method 1100 also includes providing a fore or aft portion of a second vehicle, at 1104. For example, a fore or aft portion of a second vehicle (e.g., a truck, a car, etc.), such as trailer hitch 522, may be provided. Method 1100 further includes mounting the detector portion on the fore or aft portion of the second vehicle, at 1106. For example, detector portion 502 may be mounted on trailer hitch 522.

In a particular implementation, method 1100 further includes mounting the detector portion to the fore or aft portion of the second vehicle via a mounting bracket. For example, detector portion 502 may be mounted to trailer hitch 522 by mounting bracket 520. In some such implementations, method 1100 also includes adjusting a first orientation of the detector portion with respect to a first axis, adjusting a second orientation of the detector portion with respect to a second axis, or both. For example, mounting bracket 520 may enable adjustments to the orientation of detector portion 502 with respect to one or more axes. Alternatively, method 1100 may further include magnetically mounting the detector portion to the fore or aft portion of the second vehicle. For example, detector portion 502 may include one or more magnets and may be magnetically coupled to trailer hitch 522.

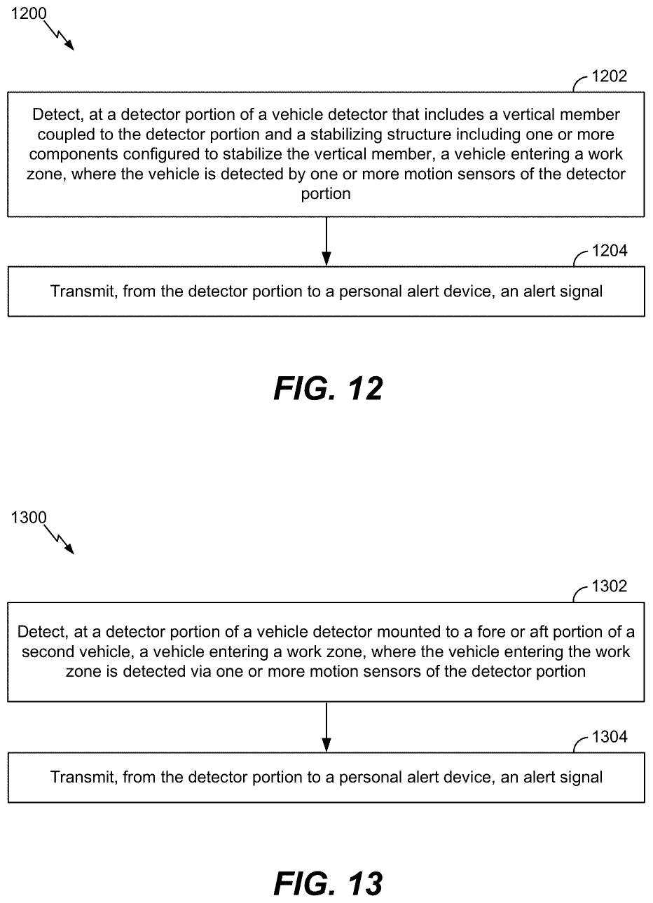

FIG. 12 illustrates an implementation of a method 1200 for transmitting an alert signal when a vehicle is detected entering a work zone. Method 1200 may be performed by vehicle detector 100, vehicle detector 702, or vehicle detector 902, as non-limiting examples.

Method 1200 includes detecting, at a detector portion of a vehicle detector that includes a vertical member coupled to the detector portion and a stabilizing structure including one or more components configured to stabilize the vertical member, a vehicle entering a work zone, at 1202. The vehicle is detected by one or more motion sensors of the detector portion. For example, one or more motion sensors 104 of detector portion 102 of vehicle detector 100 may detect when a vehicle (e.g., a train) enters a work zone.

Method 1200 further includes transmitting, from the detector portion to a personal alert device, an alert signal, at 1204. For example, a communications interface included in detector portion 102 may transmit an alert signal based detection of the vehicle entering the work zone by one or more motion sensors 104. The alert signal may be transmitted to one or more PADs, as further described with reference to FIGS. 7-9.

In some implementations, the alert signal enables the personal alert device to generate an indication. The indication may be a visual indication, an audio indication, a haptic indication, or a combination thereof. For example, one or more PADs 704 may include visual indicators (e.g., lights), audio indicators (e.g., speakers), haptic indicators (e.g., components that cause one or more PADs 704 to vibrate), or a combination thereof, based on the alert signal.

In some implementations, method 1200 further includes generating an indication at the detector portion based on detection of the vehicle entering the work zone. Generating the indication may include emitting light from one or more LEDs, emitting an audio output from a speaker, or both. For example, detector portion 102 may include visual indicator 106 and/or a speaker configured to generate visual indications and/or audio indications.

FIG. 13 illustrates another implementation of a method 1300 for transmitting an alert signal when a vehicle is detected entering a work zone. Method 1300 may be performed by vehicle detector 500, vehicle detector 702, or vehicle detector 902, as non-limiting examples.

Method 1300 includes detecting, at a detector portion of a vehicle detector mounted to a fore or aft portion of a second vehicle, a vehicle entering a work zone, at 1302. The vehicle entering the work zone is detected via one or more motion sensors of the detector portion. For example, one or more motion sensors 504 of detector portion 502 of vehicle detector 500 may detect when a vehicle (e.g., a train) enters a work zone.

Method 1300 further includes transmitting, from the detector portion to a personal alert device, an alert signal, at 1304. For example, a communications interface included in detector portion 502 may transmit an alert signal based detection of the vehicle entering the work zone by one or more motion sensors 504. The alert signal may be transmitted to one or more PADs, as further described with reference to FIGS. 7-9.

In some implementations, the alert signal enables the personal alert device to generate an indication. The indication may be a visual indication, an audio indication, a haptic indication, or a combination thereof. For example, one or more PADs 704 may include visual indicators (e.g., lights), audio indicators (e.g., speakers), haptic indicators (e.g., components that cause one or more PADs 704 to vibrate), or a combination thereof, based on the alert signal.

In some implementations, method 1300 further includes generating an indication at the detector portion based on detection of the vehicle entering the work zone. Generating the indication may include emitting light from one or more LEDs, emitting an audio output from a speaker, or both. For example, detector portion 502 may include visual indicator 506 and/or a speaker configured to generate visual indications and/or audio indications.

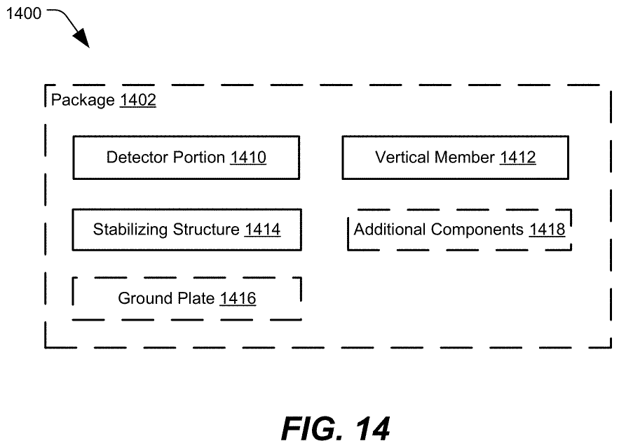

Referring to FIG. 14, a kit 1400 for a vehicle detector is illustrated. Kit 1400 includes a detector portion 1410, a vertical member 1412, and a stabilizing structure 1414. Detector portion 1410 may include or correspond to detector portion 102, a detector portion of vehicle detector 702, or a detector portion of vehicle detector 902. Vertical member 1412 may include or correspond to vertical member 110. Stabilizing structure 1414 may include or correspond to stabilizing structure 112.

Detector portion 1410 may include one or more motion sensors configured to detect when a vehicle, such as a train, enters a work zone. Vertical member 1412 may be configured to be coupled to detector portion 1410 to support detector portion 1410. Stabilizing structure 1414 includes one or more components configured to stabilize vertical member 1412, the one or more components defining a circumference around vertical member 1412.

In some implementations, kit 1400 may further include a ground plate 1416, additional components 1418, or a combination thereof. Ground plate 1416 may be coupled to vertical member 1412 and stabilizing structure 1414 to provide additional support and stabilization to vertical member 1412. Additional components 1418 may include mounting brackets, screws, inserts, nails, batteries, or other components, as non-limiting examples.

In some implementations, kit 1400 may include a package 1402. For example, package 1402 may include a box, a bag, a container, or the like. Package 1402 may include detector portion 1410, vertical member 1412, and stabilizing structure 1414. In some implementations, package 1402 may further include ground plate 1416, additional components 1418, or a combination thereof. Additionally, or alternatively, package 1402 may include a packaging medium (e.g., a packaging material), such as foam, paper, or the like. Thus, FIG. 14 describes kit 1400 for a vehicle detector.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules described herein (e.g., the functional blocks and modules in FIG. 9) may comprise processors, electronics devices, hardware devices, electronics components, logical circuits, memories, software codes, firmware codes, etc., or any combination thereof. In addition, features discussed herein relating to FIG. 9 may be implemented via specialized processor circuitry, via executable instructions, and/or combinations thereof.

Those of skill would further appreciate that the various illustrative logical blocks, modules, circuits, and algorithm steps (e.g., the logical blocks in FIGS. 10-13) described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

The above specification and examples provide a complete description of the structure and use of illustrative implementations. Although certain examples have been described above with a certain degree of particularity, or with reference to one or more individual examples, those skilled in the art could make numerous alterations to the disclosed implementations without departing from the scope of this invention. As such, the various illustrative implementations of the methods and systems are not intended to be limited to the particular forms disclosed. Rather, they include all modifications and alternatives falling within the scope of the claims, and examples other than the one shown may include some or all of the features of the depicted example. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several implementations.

The claims are not intended to include, and should not be interpreted to include, means-plus- or step-plus-function limitations, unless such a limitation is explicitly recited in a given claim using the phrase(s) “means for” or “step for,” respectively.

1. A vehicle detector configured to detect a train entering a work zone, the vehicle detector comprising:
a detector portion comprising one or more motion detectors, one or more motion detectors configured to detect a vehicle entering a work zone;
a vertical member coupled to the detector portion; and
a stabilizing structure comprising one or more components configured to stabilize the vertical member, the one or more components defining a circumference around the vertical member.

2. The vehicle detector of claim 1, wherein the one or more components comprise a sheet of material that defines a cone around the vertical member.

3. The vehicle detector of claim 1, wherein the one or more components comprise at least three members coupled to the vertical member and configured to stabilize the vertical member.

4. The vehicle detector of claim 1, wherein the one or more motion detectors comprises one or more laser beam emitters, and wherein the vehicle is detected as entering the work zone based on reflection of laser beams emitted from the one or more laser beam emitters.

5. The vehicle detector of claim 1, wherein the one or more motion detectors include a first motion detector configured to detect motion of the vehicle in a first direction, a second motion detector configured to detect motion of the vehicle in the first direction, a third motion detector configured to detect motion of the vehicle in a second direction, or a combination thereof.

6. The vehicle detector of claim 1, further comprising a ground plate coupled to the vertical member, wherein the one or more components define the circumference on the ground plate.

7. The vehicle detector of claim 1, further comprising a mounting bracket coupled to the detector portion and to the vertical member, the mounting bracket configured to enable the detector portion to be rotated in a first direction, in a second direction, or both, wherein the first direction is perpendicular to the second direction.

8. The vehicle detector of claim 7, wherein the mounting bracket is configured to enable the detector portion to be rotated in the first direction in 15 degree increments, in the second direction in 90 degree increments, or both.

9. The vehicle detector of claim 1, further comprising one or more level indicators, the one or more level indicators configured to indicate an orientation of the detector portion with respect to a first axis, a second axis, or both, wherein the first axis is perpendicular to the second axis.

10. The vehicle detector of claim 1, wherein the detector portion further comprises one or more alarm indicators configured to indicate an alarm based on detection of the vehicle entering the work zone, and wherein the alarm is a visual alarm, an audio alarm, or both.

11. A vehicle detector configured to detect a train entering a work zone, the vehicle detector comprising:
a detector portion comprising one or more motion detectors, the one or more motion detectors configured to detect a vehicle entering a work zone; and
means for mounting the detector portion to a fore or aft portion of a second vehicle.

12. The vehicle detector of claim 11, wherein the means for mounting comprises a mounting bracket.

13. The vehicle detector of claim 12, wherein the mounting bracket is configured to enable the detector portion to be rotated in a first direction, in a second direction, or both, and wherein the first direction is perpendicular to the second direction.

14. The vehicle detector of claim 11, wherein the means for mounting comprises one or more magnets.

15. A system comprising:
a vehicle detector comprising:
a detector portion comprising one or more motion sensors, the one or more motion sensors configured to detect a vehicle entering a work zone;
a vertical member coupled to the detector portion; and
a stabilizing structure comprising one or more components to stabilize the vertical member, the one or more components defining a circumference around the vertical member.

16. The system of claim 15, wherein the detector portion further comprises a communications interface configured to transmit an alert signal based on detection of the vehicle entering the work zone.

17. The system of claim 16, further comprising one or more personal alert devices communicatively coupled to the detector portion, the one or more personal alert devices configured to generate an indication based on receipt of the alert signal from the communication interface.

18. The system of claim 17, wherein the indication comprises a visual indication, an audio indication, a haptic indication, or a combination thereof.

19. The system of claim 16, further comprising a portable warning device communicatively coupled to the detector portion, the portable warning device configured to generate an indication based on receipt of the alert signal from the communication interface.

20. The system of claim 19, wherein the indication comprises a visual indication, an audio indication, or both.
